(19) United States
(12) Patent Application Publication
(10) Pub. No.: US 2006/0131966 A1
(43) Pub. Date: Jun. 22, 2006

(54) Motor, motor system, motor elements and method of assembly thereof

(76) Inventors: Stanley W. Janisiewicz, Endwell, NY (US); Koen A. Gieskes, Deposit, NY (US)

Correspondence Address: Schmeiser, Olsen & Watts LLP, 3 Lear Jet Lane, Suite 201, Latham, NY, 12110, US

(21) Appl. No.: 11/013,777

(22) Filed: Dec. 16, 2004

(51) Int. Cl. H02K 41/00

(52) U.S. Cl. 310/12; 310/168

(57) ABSTRACT

A variable reluctance linear motor comprising a motor system, that includes a bearing assembly that is incorporated into the motor so as to guarantee that an air gap is maintained between the motor and stator during relative motion there between. The invention further includes means to replace the bearing assembly(s) and winding(s) that can be used with the motor and a method of assembly.

### BACKGROUND OF THE INVENTION

1. Technical Field

This invention relates to motors and, more particularly to a variable reluctance linear motor system, parts thereof, and the assembly thereof.

2. Related Art

Variable reluctance linear motor systems comprising a motor and a stator are well known. As is the fact that a variable reluctance linear motor system requires a small air-gap (e.g., 0.003″ to 0.008″) between the motor and the stator as the motor and the stator move relative to each other in order to aid in optimizing motor force and efficiency. Establishing and maintaining this air-gap is difficult and costly when there is a tolerance buildup over several parts and dimensions. Another issue that variable reluctance linear motor systems encounter is that if a portion of a motor fails, such as a winding, a bearing assembly, and the like, then the whole motor must be replaced.

A need exists for a variable reluctance linear motor system that overcomes at least one of the aforementioned, and, also, other deficiencies in the art.

### SUMMARY OF THE INVENTION

The present invention overcomes the tolerance buildup and the replaceability of portions of a variable reluctance linear motor system by creating a new and unique way of assembling the motor portion of the system out of subassemblies that are easier to machine to final tolerance.

In a first general aspect, the present invention provides a variable reluctance linear motor system comprising:

a motor having a plurality of bodies;

a stator; and

means for controlling a gap between said motor and said stator, wherein said gap remains constant as one of said motor and said stator moves relative to the other.

In a second general aspect, the present invention provides variable reluctance linear motor comprising:

a first body;

a second body;

a stator, operatively positioned between said first and second bodies, for axial relative movement between said stator and said first body and said second body; and

a bearing assembly, replaceably attached, between said first body and said second body for maintaining a gap between at least one of said stator and said first body and said stator and said second body.

In a third general aspect, the present invention provides a method of assembling a variable reluctance linear motor system, said method comprising:

providing a first body;

providing a second body;

providing a stator, positioned between said first body and said second body for linear slideable relative movement between said stator and said first and second bodies; and

replaceably attaching a bearing surface to maintain a gap between both said stator and said first body and said stator and said second body.

In a fourth general aspect, the present invention provides a bearing assembly for use in a variable reluctance linear motor system having a first body, a second body, and a stator, wherein said bearing assembly comprises:

a bearing surface, replaceably attachable between said first body and said second body, configured to maintain a gap between both said stator and said first body and said stator and said second body.

In a fifth general aspect, the present invention provides a winding for use in a variable reluctance linear motor system having a first body, a second body, and a stator, wherein said winding comprises:

at least one conductive loop configured for replaceable attachment to one of said first and said second bodies.

### BRIEF DESCRIPTION OF THE DRAWINGS

A complete understanding of the present invention may be obtained by reference to the accompanying drawings, when considered in conjunction with the subsequent detailed description, in which:

FIG. 1 is a top, perspective view of an embodiment of an assembled motor, in accordance with the present invention.

FIG. 2 is a close-up perspective view of an embodiment of a bearing assembly in accordance with the present invention.

FIG. 3 is an exploded top, perspective view of a first phase of assembly of an embodiment of the motor in accordance with the present invention.

FIG. 4 is an exploded top, perspective view of a second phase of assembly of an embodiment of the motor in accordance with the present invention.

FIG. 5 is a top, perspective view of a third phase of assembly of an embodiment of the motor in accordance with the present invention.

FIG. 6 is a top, perspective view of an embodiment of a fully assembled motor system, in accordance with the present invention.

FIG. 7 is an end view of an embodiment of a motor system, in accordance with the present invention.

### DETAILED DESCRIPTION OF THE INVENTION

Although certain embodiment of the present invention will be shown and described in detail, it should be understood that various changes and modification may be made without departing from the scope of the appended claims. The scope of the present invention will in no way be limited to the number of constituting components, the materials thereof, the shapes thereof, the relative arrangement thereof, etc. and are disclosed simply as an example of an embodiment. The features and advantages of the present invention are illustrated in detail in the accompanying drawings, wherein like reference numerals refer to like elements throughout the drawings.

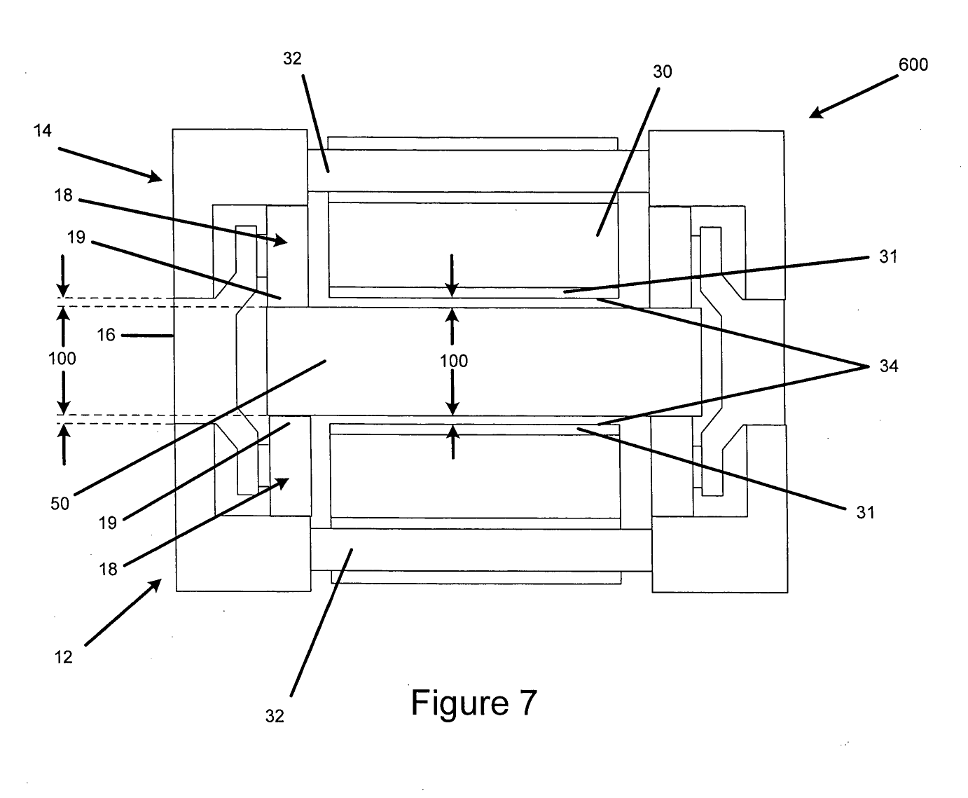

The present invention pertains to a variable reluctance linear motor system comprising a motor and a stator, and more particularly to the motor apparatus, parts thereof, and assembly of the motor. The inventive apparatus of the motor and the assembly method thereof provides a cost effective and less complicated manner in which to create and maintain an air-gap 100 (see FIG. 7) in the range of approximately 0.003″ to 0.008″ between the motor and the stator as one moves relative to the other by eliminating the tolerance buildup over several parts and dimensions. Reducing the number of individual parts having critical dimensions in the motor reduces the overall cost of the motor, as well. The apparatus and method of assembly of the motor also allows for replacement of individual parts of the motor in case of failure without having to replace the entire motor.

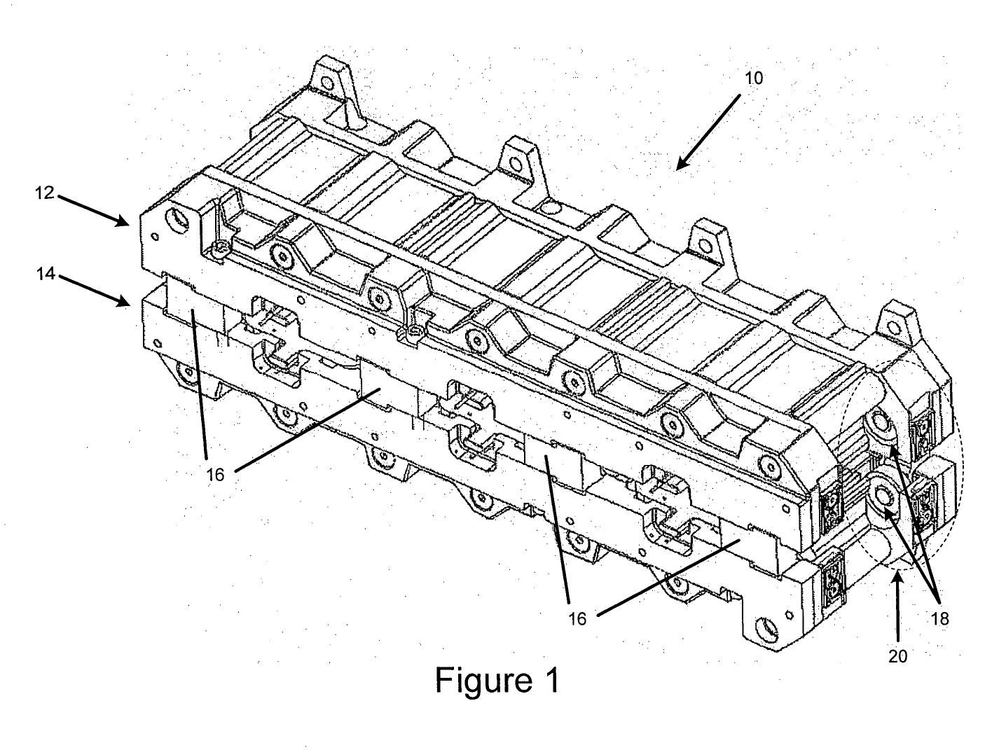

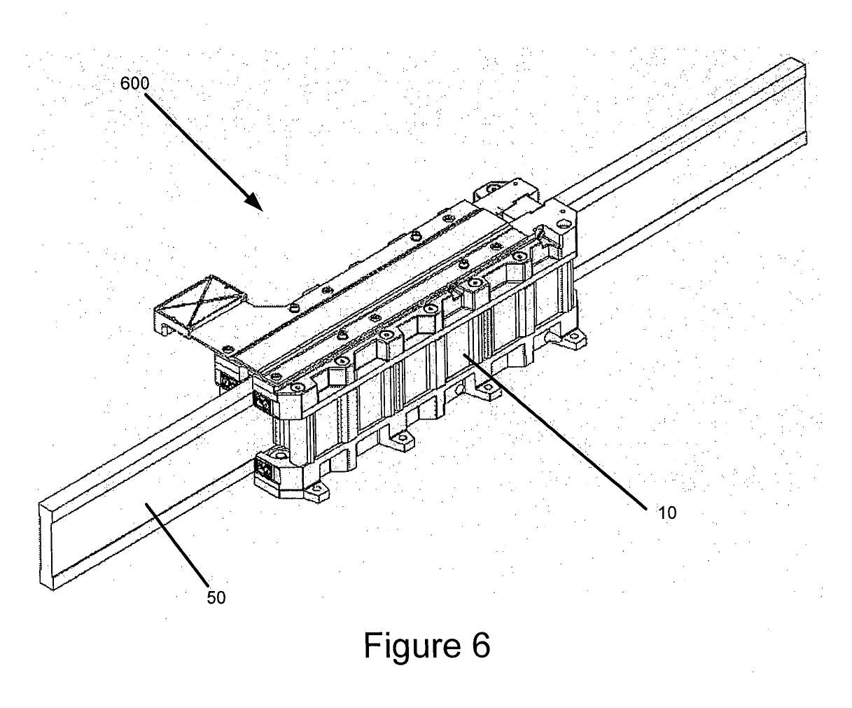

Turning now to FIG. 1, which depicts an embodiment of a motor 10 of the present invention, said motor 10 comprising at least two bodies, a first body 12, and a second body 14. The first and second bodies 12, 14 may be plate-like in configuration. Located between and separating the first and second bodies 12, 14, are a plurality of bearing members, or assemblies 20. The bearing assembly 20 include a spacer block 16 that creates a space between the first body 12 and the second body 14 when assembled and allows for the passage of a stator 50 (See FIG. 6) through motor 10. The bearing assembly 20 are releasably attached to the first and second bodies 12, 14. The bearing assembly 20 further includes a plurality of bearing surfaces 19 that in one embodiment are provided from a plurality of roller bearings 18. The bearing assembly 20 is manufactured such that as the stator 50 rides on the bearing surfaces 19 of the rollers bearings 18, wherein an air-gap 100 (See FIG. 7) in the range of approximately 0.003″-0.008″ is maintained between the motor 10 and the stator 50.

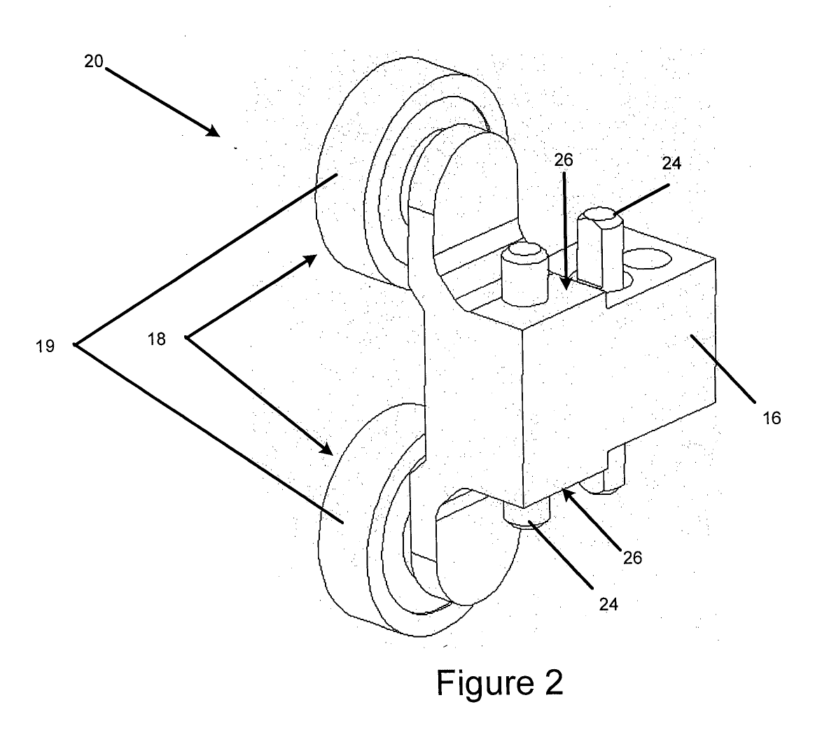

FIG. 2 depicts a close-up view of one embodiment of a bearing member, or assembly 20, which comprises two roller bearings 18 mounted on the spacer block 16. The two roller bearings 18 include two bearing surfaces 19. The bearing assembly 20 also includes locating pins 24 inserted through the spacer block 16. The bearing assembly 20 is manufactured such that the distance between bearing surfaces 19 is precisely maintained, and surfaces 26 are precisely machined. The locating pins 24 are for alignment of the bearing assembly 20 between the first body 12 and second body 14 when assembling motor 10. Bearing assembly 20 contains the dimensions such that when the bearing assembly 20 is assembled between the first body 12 and the second body 14 to create motor 10, an air-gap 100 (See FIG. 7) in the range of approximately 0.003″-0.008″ will be created and maintained between the motor 10 and the stator 50 as one moves relative to the other.

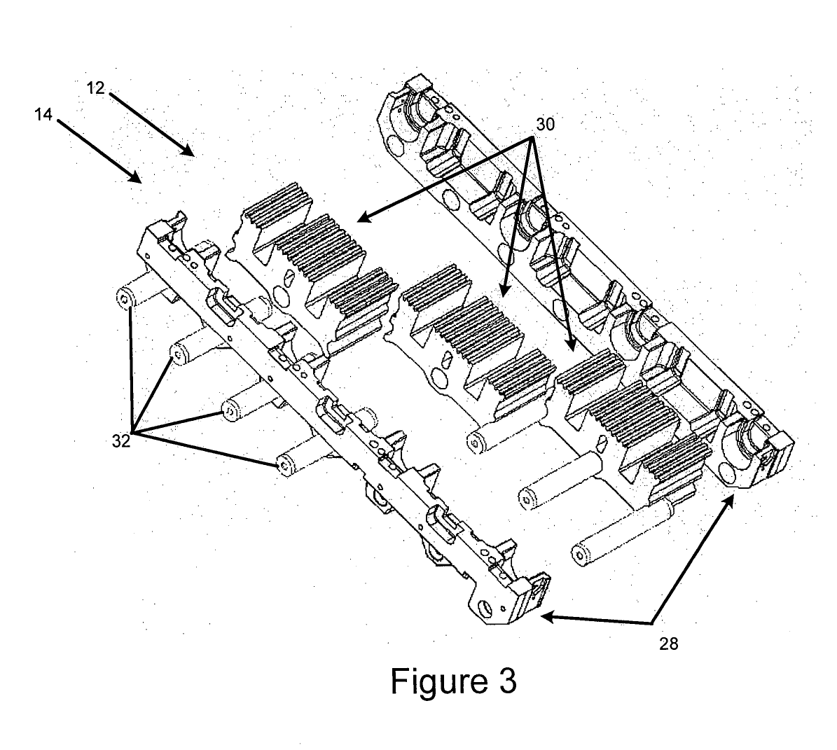

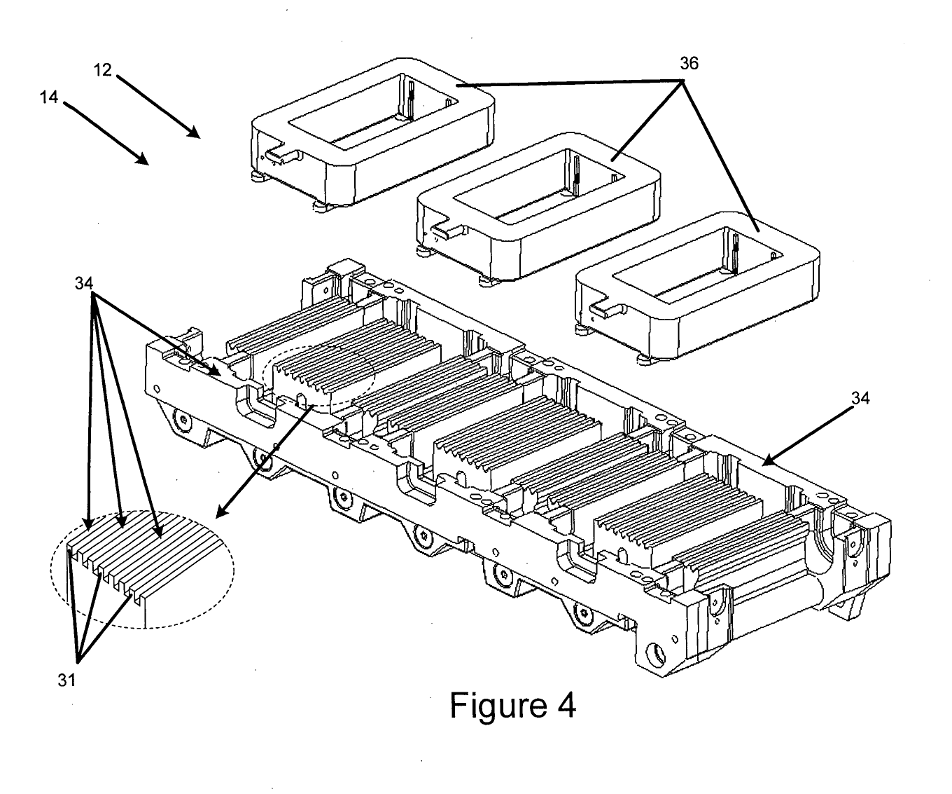

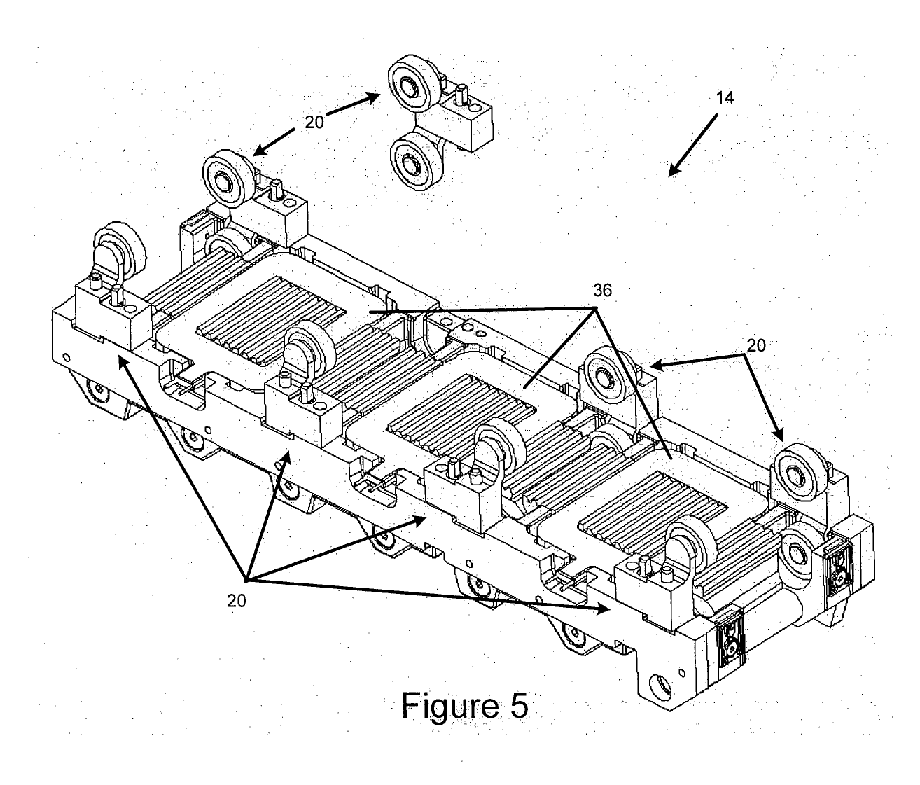

Referring now to FIGS. 3-5, these show the various stages of the assembly of motor 10. Similarly, the figures also show the method of disassembly and/or methods of replacing various elements, or parts, of the motor 10. The first stage of assembly of motor 10 comprises assembling the first body 12 and the second body 14. First body 12 and second body 14 comprise sides 28, motor cores 30, and rods 32. The motor cores 30 comprise stacks of laminations. The first body 12 is assembled as follows. Rods 32 are fit into one of sides 28. The laminations are then stacked on the rods 32 to create the motor core 30. Following creation of motor core 30, the remaining side of sides 28 is fit on to the other side of rods 32. This partial assembly of first body 12 is impregnated in adhesive and heat-treated, then surfaces 34 of both teeth 31 and top of sides 28 are precisely machined typically with a grinder to create a flat surface within ±0.00025″. Then machined into sides 28 are any remaining features, such as the holes for locating pins 24 and slots for bearing assembly 20. Windings 36 assembled on to the motor cores 30 complete the assembly of first body 12 of motor 10. Assembly of the second body 14 of motor 10 follows the above-described process described. Next added to second body 14 are bearing assemblies 20. Lastly, assembly of first body 12 onto the second body 14 completes the assembly of motor 10. The machined surfaces 26 on spacer block 16 of bearing assembly 20 mate with machined surfaces 34 of first body 12 and second body 14.

It should be apparent to one skilled in the art that although the above described embodiments include roller bearings 18 as part of the bearing assembly 20, there are other configurations that are possible. For example, other bearing types (e.g., ball/needle bearings, etc.) may be used to provide a suitable bearing surface 19.

It should be further apparent to one skilled in the art, that due to the capability to assemble and/or disassemble the motor 10 as discussed, effectively most all parts of the motor 10 can be readily accessed for replacement. As a result, for example, a winding 36, or several windings 36, can be replaced if necessary without the need to replace an entire motor 10 assembly as can be the bearing assemblies 20.

Turning to FIG. 6, which shows a perspective view of an assembled variable reluctance linear motor system 600 comprising motor 10 and stator 50. The motor 10 and stator 50 move relative to each other. That is either the stator 50 is stationary, while the motor 10 moves or the motor 10 is stationary while the stator 50 moves.

Finally, FIG. 7 shows an end view variable reluctance linear motor system 600 and the air-gap 100 located between the surfaces 34 of the teeth 31 of the motor core 30 of the first body 12 and the second body 14 and the surfaces on the stator 50. The distance of the air gap 100 between motor 10 and stator 50 is approximately 0.003″-0.008″.

Since other modification and changes varied to fit particular operating requirements and environments will be apparent to those skilled in the art, the invention is not considered limited to the example chosen for purposes of disclosure, and covers all changes and modification which do not constitute departures from the true spirit and scope of this invention.

What is claimed is:

1. A variable reluctance linear motor system comprising:
a motor having a plurality of bodies;
a stator; and
a means for controlling a gap between said motor and said stator, wherein said gap remains constant as one of said motor and said stator moves relative to the other.

2. A variable reluctance linear motor system comprising:
a first body;
a second body;
a stator, operatively positioned between said first and second bodies, for axial relative movement between said stator and said first body and said second body; and
at least one bearing assembly, replaceably attached, between said first body and said second body for maintaining a gap between at least one of said stator and said first body and said stator and said second body.

3. The motor system of claim 2, wherein said at least one bearing assembly further comprises at least one bearing.

4. A method of assembling a variable reluctance linear motor system, said method comprising:
providing a first body;
providing a second body;
providing a stator, positioned between said first body and said second body for linear slideable relative movement between said stator and said first and second bodies; and
replaceably attaching a bearing surface to maintain a gap between both said stator and said first body and said stator and said second body.

5. The method of claim 4, wherein said bearing surface includes at least one bearing.

6. A bearing assembly for use in a variable reluctance linear motor system having a first body, a second body, and a stator, wherein said bearing assembly comprises:
a bearing surface, replaceably attachable between said first body and said second body, configured to maintain a gap between both said stator and said first body and said stator and said second body.

7. The bearing assembly of claim 6, wherein said bearing surface is on at least one roller bearing.

8. A winding for use in a variable reluctance linear motor system having a first body, a second body, and a stator, wherein said winding comprises:
at least one conductive loop configured for replaceable attachment to one of said first and said second bodies.
